(19) United States
(12) Patent Application Publication
(10) Pub. No.: US 2023/0110403 A1
(43) Pub. Date: Apr. 13, 2023

(54) Engraving device

(71) Applicants: Tianle Cheng, Dongguan (CN); Jifa Huang, Dongguan (CN); Hua Liao, Dongguan (CN)

(72) Inventors: Tianle Cheng, Dongguan (CN); Jifa Huang, Dongguan (CN); Hua Liao, Dongguan (CN)

(21) Appl. No.: 17/936,834

(22) Filed: Sep. 29, 2022

(30) Foreign Application Priority Data
Oct. 11, 2021 (CN) 202111182226.4

(51) Int. Cl. B23Q 11/00

(52) U.S. Cl. CPC B23Q 11/0046; B23Q 11/0089

(57) ABSTRACT

An engraving device includes a material processing platform disposed on a base frame and including suction holes and a pneumatic joint communicating with the suction holes; a gantry bracket disposed across both sides of the base frame; a spindle motor disposed on the gantry bracket; a processing bit operatively connected to the spindle motor; a dust collector disposed on the processing bit; and a driving mechanism operatively connected to the spindle motor and configured to move along the X-axis, Y-axis, and Z-axis.

### FIELD OF THE INVENTION

The invention relates to engraving devices and more particularly to an engraving device for domestic use having improved characteristics.

### BACKGROUND OF THE INVENTION

In order to prevent dust, generally, a commercially available engraving device is equipped with an integrated dust collector or a two-stage removable dust collector. However, the former is inconvenient to operate when installed on the engraving device due to its large volume, which is easy to interfere with the bit and motor; and the latter has an upper cover and a lower cover, compared with the integrated dust collector, the installation effect of the latter is improved due to the small volume of the upper cover, but the upper cover and the lower cover are only connected by magnets, resulting in the vibration of the lower cover and noise during dust collection, and its dust collection effect is poor.

Thus, the need for improvement still exists.

### SUMMARY OF THE INVENTION

The invention aims to provide an engraving device for better dust collection and dust prevention to solve the above technical problems.

It is therefore an object of the invention to provide an engraving device comprising a base frame; a material processing platform disposed on the base frame and comprising a plurality of suction holes and a pneumatic joint communicating with the suction holes; a gantry bracket disposed across both sides of the base frame; a spindle motor disposed on the gantry bracket; a processing bit operatively connected to the spindle motor; a dust collector disposed on the processing bit; and a driving mechanism operatively connected to the spindle motor and configured to move along the X-axis, Y-axis and Z-axis.

Furthermore, the dust collector comprises an upper cover, a middle cover and a lower cover, wherein, the upper cover and the processing bit are snap connected. The bottom of the upper cover is magnetically connected to the middle cover, and the bottom of the middle cover is magnetically connected to the lower cover.

Furthermore, a plurality of magnets are respectively fixed in the upper cover, the middle cover and the lower cover by screws.

Furthermore, the upper cover body comprises an upper cover plate on which a circular groove and a protruding hollow cylinder are arranged at interval, a bottom clamping slot is arranged at the bottom of the upper cover plate, the bottom of the circular groove is provided with a through hole which is communicated with the middle cover, the hollow cylinder is communicated with the middle cover, the top surface of the hollow cylinder is communicated with the pipe of the dust collecting device, and the circular groove is connected to the processing bit.

Furthermore, the middle cover is hollow, the top edge of the middle cover is provided with a first clamping slot, the bottom edge of the middle cover is provided with a second clamping slot, and the first clamping slot and the bottom clamping slot are snap connected.

Furthermore, the lower cover comprises a lower cover plate, a third clamping slot is arranged on the top surface of the lower cover plate and engaged with the second clamping slot; the lower cover is provided with a circular through groove, and the peripheral side of the circular through groove is provided with an insertion hole in which a brush is implanted; and the circular through groove is communicated with the middle cover and the hollow cylinder to form a dust collection channel.

Furthermore, the driving mechanism comprises an X-axis driving mechanism, a Y-axis driving mechanism and a Z-axis driving mechanism, wherein, the X-axis driving mechanism comprises an X-axis driving motor, the output shaft of the X-axis driving motor is connected to an X-axis screw which spans the gantry bracket, and X-axis guide shafts are respectively arranged on the upper and lower sides of the X-axis screw; a connector is arranged on the X-axis screw and the X-axis guide shafts, and the connector is connected to the Z-axis driving mechanism.

Furthermore, the Z-axis driving mechanism comprises a Z-axis driving motor of which the motor is connected to the connector, the output shaft of the Z-axis driving motor is connected to a Z-axis screw of which both sides are respectively provided with a Z-axis guide shaft, the end of the Z-axis screw, and both ends of the Z-axis guide shaft are connected to the connector after passing through a clamp and the spindle motor, and the Z-axis driving motor drives the spindle motor to move vertically.

Furthermore, the Y-axis driving mechanism is arranged on the base frame and connected to the bottom of the processing platform. In addition, the Y-axis driving mechanism comprises a Y-axis driving motor of which the output shaft is connected to a Y-axis screw, Y-axis guide shafts are respectively arranged on both sides of the Y-axis screw, and the Y-axis driving mechanism drives the processing platform to move on the Y-axis.

Furthermore, both sides of the gantry bracket are respectively provided with a dust baffle, one side of the X-axis driving motor is provided with a limit switch, and the end of the Y-axis guide shafts away from the Y-axis driving motor is provided with the limit switch.

The has the following advantages and benefits in comparison with the conventional art: the invention provides an engraving device, which comprises a base frame. A processing platform is arranged on the base frame, and a grid of suction holes are arranged on the processing platform. The suction holes are connected to a vacuum extraction device through a pneumatic joint on the side of the base frame. A gantry bracket is provided across both sides of the base frame and provided with a spindle motor. The output shaft of the spindle motor is connected to a processing bit sleeved with a dust collector which is connected to a dust suction device. The spindle motor is connected to a driving mechanism which drives the spindle motor to move along the X-axis, Y-axis and Z-axis. The suction holes arranged on the processing platform of the engraving device, which are connected to the vacuum extraction device, and the dust collector arranged on the spindle motor realize double dust collection, improving the dust collection effect.

The above and other objects, features and advantages of the invention will become apparent from the following detailed description taken with the accompanying drawings

### BRIEF DESCRIPTION OF THE DRAWINGS

FIG. 1 is a perspective view of an engraving device according to an embodiment of the invention;

FIG. 2 is a side view of the engraving device according to the embodiment of the invention;

FIG. 3 is an exploded view of the dust collector of the engraving device according to the embodiment of the invention;

FIG. 4 is an exploded bottom view of the dust collector of the engraving device according to the embodiment of the invention;

FIG. 5 is a perspective view of the engraving device according to the embodiment of the invention, viewed from the top; and

FIG. 6 is another view of the engraving device according to the embodiment of the invention, viewed from the top.

### DETAILED DESCRIPTION OF THE INVENTION

The invention provide an engraving device that can better suck and prevent dust.

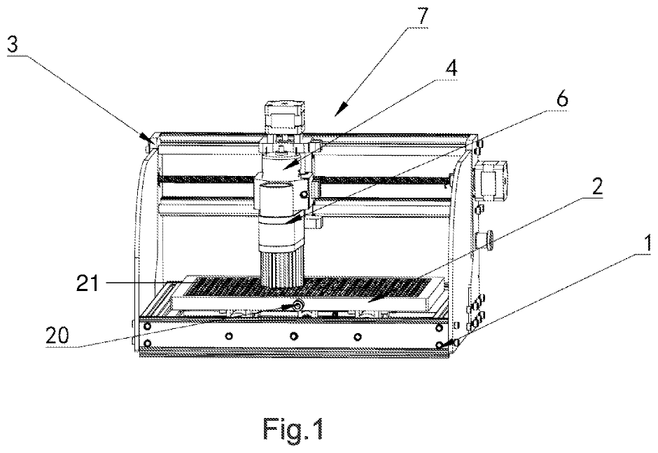

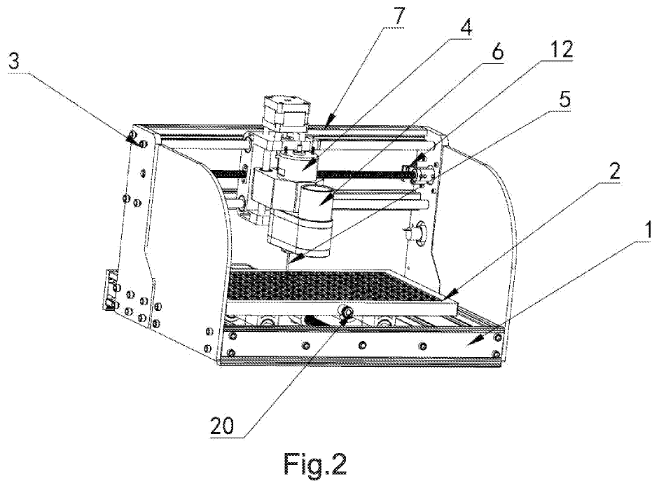

Please refer to FIGS. 1 to 6, an engraving device according to an embodiment of the invention is shown and comprises a base frame 1, a processing platform 2 arranged on the base frame 1, and a plurality of suction holes 21 arranged on the processing platform 2. The suction holes are connected to a vacuum extraction device (not shown) through a pneumatic joint 20 on the side of the base frame 1.

A gantry bracket 3 is arranged across both sides of the base frame 1 and provided with a spindle motor 4. The output shaft of the spindle motor 4 is connected to a processing bit 5 sleeved with a dust collector 6 which is connected to a dust suction device 6. The spindle motor 4 is connected to a driving mechanism 7 which drives the spindle motor 4 to move along the X-axis, Y-axis and Z-axis.

In the embodiment, the suction holes 21 are arranged on the processing platform 2 and connected to the vacuum extraction device. The dust collector 6 is arranged on the spindle motor 4 of the engraving device. The dust collector 6 and the suction holes 21 improve the dust collection effect of the engraving device.

Furthermore, the dust collector 6 comprises an upper cover 61, a middle cover 62 and a lower cover 63, wherein, the upper cover 61 and the processing bit 5 are snap connected. The bottom of the upper cover 61 is magnetically connected to the middle cover 62, and the bottom of the middle cover 62 is magnetically connected to the lower cover 63.

In the embodiment, the dust collector 6 adopts a three-stage detachable structure, comprising an upper cover 61, a middle cover 62 and a lower cover 63. Magnets are arranged in the three covers for the magnetic connection of the three covers.

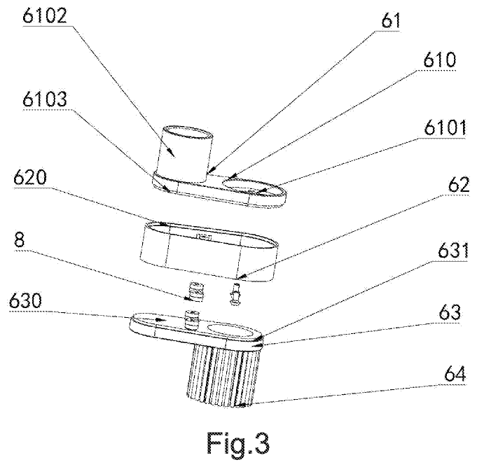

Furthermore, as shown in FIG. 3, a plurality of magnets 8 are respectively fixed in the upper cover 1, the middle cover 2 and the lower cover 3 by screws.

In the embodiment, the plurality of magnets 8 are respectively fixed in the upper cover 1, the middle cover 2 and the lower cover 3 by screws.

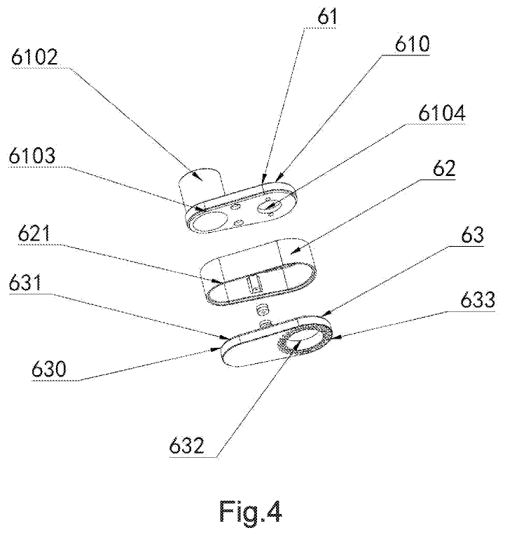

Furthermore, as shown in FIG. 3 and FIG. 4, the upper cover body 61 comprises an upper cover plate 610 on which a circular groove 6101 and a protruding hollow cylinder 6102 are arranged at interval, a bottom clamping slot 6103 is arranged at the bottom of the upper cover plate 610, the bottom of the circular groove 6101 is provided with a through hole 6104 which is communicated with the middle cover 62, the hollow cylinder 6102 is communicated with the middle cover 62, the top surface of the hollow cylinder 6102 is communicated with the pipe of the dust collecting device, and the circular groove 6101 is connected to the processing bit 5.

In the embodiment, the upper cover plate 610 of the upper cover 61 is provided with a circular groove 6101 and a protruding hollow cylinder 6102 at intervals on the upper cover plate 610. The circular groove 6101 is connected to the processing bit 5, and the top surface of the hollow cylinder 6102 is connected to the pipe of the dust collecting device. When arranging the dust collector, it only needs to fix the circular groove of the upper cover 61 of the dust collector on the output shaft of the motor of the engraving device to wrap around the processing bit, and then magnetically fix the middle cover 62 and the lower cover 63, which is convenient to install.

Furthermore, the middle cover 62 is hollow, the top edge of the middle cover 62 is provided with a first clamping slot620, the bottom edge of the middle cover 62 is provided with a second clamping slot 621, and the first clamping slot 620 and the bottom clamping slot 6103 are snap connected.

In the embodiment, in addition to magnetic connection, the upper cover 62 and the upper cover 61 are also snap connected. The first clamping slot 620 is arranged at the top inner side of the middle cover 62, and snap connected to the bottom clamping slot of the upper cover 61, which more stabilizes the dust collector structure.

Furthermore, as shown in FIG. 4, the lower cover 63 comprises a lower cover plate 630, a third clamping slot 631 arranged on the top surface of the lower cover plate 630 and engaged with the second clamping slot 621; the lower cover 63 is provided with a circular through groove 632, and the peripheral side of the circular through groove 632 is provided with an insertion hole 633 in which a brush 64 is implanted; and the circular through groove 632 is communicated with the middle cover 62 and the hollow cylinder 6102 to form a dust collection channel.

In the embodiment, the top surface of the lower cover plate 630 is provided with a third clamping slot 631 which is snap connected to the second clamping slot 621. The cover 63 is provided with a circular through groove 631. The brush 64 is implanted around the through slot 631 which is communicates with the middle cover 62 and the hollow cylinder 6103 to form a dust collection channel. When the engraving device works, the three-stage dust collector collects dust. The dust and debris are brushed by the brush 4, and enter the middle cover 62 of the dust collector from the opening of the through groove 631 of the lower cover 63 of the dust collector under vacuum suction. After passing through the middle of the dust collector, the dust and debris are sucked into the dust collector along the protruding hollow cylinder 6102 of the upper cover of the dust collector.

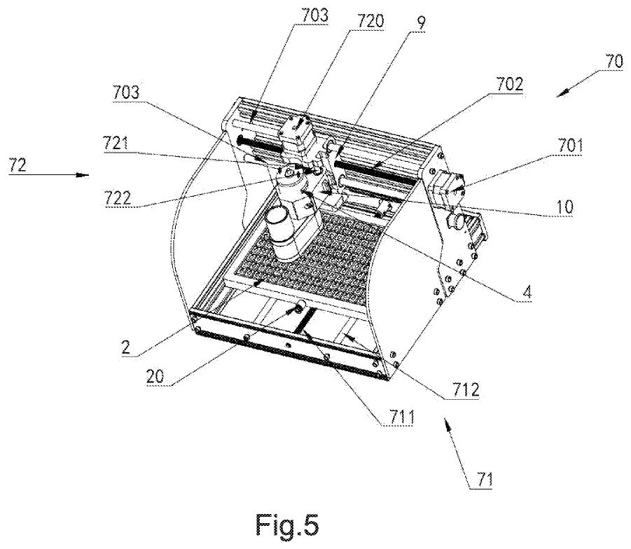

Furthermore, as shown in FIG. 5, the driving mechanism 7 comprises an X-axis driving mechanism 70, a Y-axis driving mechanism 71 and a Z-axis driving mechanism 72, wherein, the X-axis driving mechanism 70 comprises an X-axis driving motor 701, the output shaft of the X-axis driving motor 701 is connected to an X-axis screw 702 which spans the gantry bracket 3, and X-axis guide shafts 703 are respectively arranged on the upper and lower sides of the X-axis screw 702; a first connector 9 is arranged on the X-axis screw 702 and the X-axis guide shafts 703, and the first connector 9 is connected to the Z-axis driving mechanism 72.

In the embodiment, the X-axis driving mechanism 70, the Y-axis driving mechanism 71 and the Z-axis driving mechanism 72 drive the spindle motor 4 to move along the X-axis, Y-axis, and Z-axis respectively. The X-axis driving mechanism is provided in the X-axis direction. The X-axis driving mechanism 70 comprises an X-axis driving motor 701 of which the output shaft is connected to the X-axis screw 702. The x-axis screw 702 spans the gantry bracket 3. The upper and lower sides of the X-axis screw 702 are respectively provided with an X-axis guide shaft 703. The X-axis screw 702 rotates to push the connector 9 to move horizontally in the X-axis direction. The X-axis guide shaft 703 is sleeved on the connector 9 and moves in the X-axis horizontal direction along the X-axis guide shaft 703.

Furthermore, as shown in FIG. 5, the Z-axis driving mechanism 72 comprises a Z-axis driving motor 720 of which the motor is connected to the connector 9, the output shaft of the Z-axis driving motor 720 is connected to a Z-axis screw 721 of which both sides are respectively provided with a Z-axis guide shaft 722, the end of the Z-axis screw 721, and both ends of the Z-axis guide shaft 722 are connected to the connector 9 after passing through a clamp 10 and the spindle motor 4, and the Z-axis driving motor 720 drives the spindle motor 4 to move vertically.

In the embodiment, the Z-axis driving motor 720 is connected to the connector 9, the end of the Z-axis screw 721 and both ends of the Z-axis guide shaft 722 are connected to the connector 9 after passing through a clamp 10, the Z-axis driving motor 720 drives the spindle motor 4 to move vertically, and both sides of the Z-axis driving motor 720 are provided with Z-axis guide shafts for assisting the spindle motor 4 to move stably in the vertical direction.

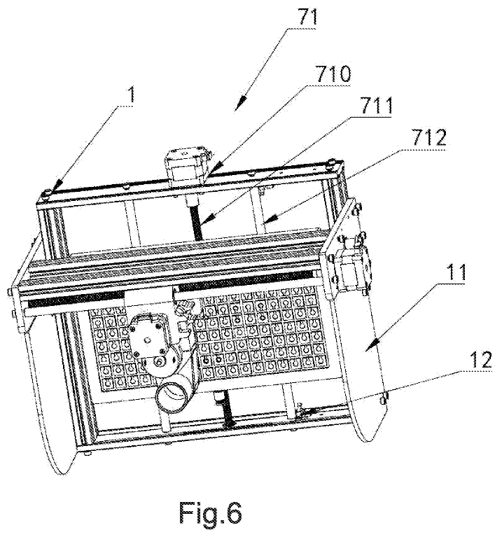

Furthermore, as shown in FIG. 6, the Y-axis driving mechanism 71 is arranged on the base frame 1 and connected to the bottom of the processing platform 2. In addition, the Y-axis driving mechanism 71 comprises a Y-axis driving motor 710 of which the output shaft is connected to a Y-axis screw 711, Y-axis guide shafts 712 are respectively arranged on both sides of the Y-axis screw 711, and the Y-axis driving mechanism 71 drives the processing platform 2 to move on the Y-axis.

In the embodiment, the Y-axis driving mechanism 71 is connected to the bottom of the processing platform 2, and comprises a Y-axis driving motor 710 of which the output shaft is connected to a Y-axis screw 711. Each side of the Y-axis screw 711 is provided with a Y-axis guide shaft 712.

Furthermore, as shown in FIG. 6, both sides of the gantry bracket 3 are respectively provided with a dust baffle 11, one side of the X-axis driving motor 701 is provided with a limit switch 12, and the end of the Y-axis guide shafts 711 away from the Y-axis driving motor 710 is provided with the limit switch 12.

In the embodiment, each side of the gantry bracket 3 is provided with a dust baffle 11 for blocking dust. The side of the X-axis driving motor 701 is provided with a limit switch 12, and the end of the Y-axis guide shaft 711 away from the Y-axis driving motor 710 is provided with a limit switch 12 which defines the movement distance of the driving motor on the X-axis, and the limit switch 12 on the Y-axis defines the movement distance of the processing platform 2 on the Y-axis.

In brief, the invention provides an engraving device comprises a base frame. A processing platform is arranged on the base frame, and a plurality of suction holes are arranged on the processing platform. The suction holes are connected to a vacuum extraction device through a pneumatic joint on the side of the base frame. A gantry bracket is arranged across both sides of the base frame and provided with a spindle motor. The output shaft of the spindle motor is connected to a processing bit sleeved with a dust collector which is connected to a dust suction device. The spindle motor is connected to a driving mechanism which drives the spindle motor to move along the X-axis, Y-axis and Z-axis. The suction holes arranged on the processing platform of the engraving device, which are connected to the vacuum extraction device, and the dust collector arranged on the spindle motor realize a double dust collection, improving the dust collection effect.

While the invention has been described in terms of preferred embodiments, those skilled in the art will recognize that the invention can be practiced with modifications within the spirit and scope of the appended claims.

What is claimed is:

1. An engraving device, comprising:
a base frame;
a material processing platform disposed on the base frame and comprising a plurality of suction holes and a pneumatic joint communicating with the suction holes;
a gantry bracket disposed across both sides of the base frame;
a spindle motor disposed on the gantry bracket;
a processing bit operatively connected to the spindle motor;
a dust collector disposed on the processing bit; and
a driving mechanism operatively connected to the spindle motor and configured to move along the X-axis, Y-axis, and Z-axis.

2. The engraving device according to claim 1, wherein the dust collector comprises an upper cover, a middle cover, and a lower cover; wherein the upper cover and the processing bit are connected together; wherein a bottom of the upper cover is magnetically connected to the middle cover; and wherein a bottom of the middle cover is magnetically connected to the lower cover.

3. The engraving device according to claim 2, further comprising a plurality of magnets threadedly secured to the upper cover, the middle cover, and the lower cover respectively.

4. The engraving device according to claim 2, wherein the upper cover body comprises an upper cover plate on which a circular groove and a protruding hollow cylinder are disposed, a bottom clamping slot disposed at a bottom of the upper cover plate, a bottom of the circular groove is provided with a through hole which communicates with the middle cover, the hollow cylinder communicates with the middle cover, a top surface of the hollow cylinder communicates with the dust collector, and the circular groove is connected to the processing bit.

5. The engraving device according to claim 4, wherein the middle cover is hollow, a top edge of the middle cover is provided with a first clamping slot, a bottom edge of the middle cover is provided with a second clamping slot, and the first clamping slot and the bottom clamping slot are connected together.

6. The engraving device according to claim 4, wherein the lower cover comprises a lower cover plate; wherein a third clamping slot is disposed on the top surface of the lower cover plate and engaged with the second clamping slot; wherein the lower cover is provided with a circular through groove; wherein a peripheral side of the circular through groove is provided with an insertion hole with a brush disposed therein; and wherein the circular through groove communicates with both the middle cover and the hollow cylinder.

7. The engraving device according to claim 1, wherein the driving mechanism comprises an X-axis driving mechanism, a Y-axis driving mechanism, and a Z-axis driving mechanism; wherein the X-axis driving mechanism comprises an X-axis driving motor, an output shaft of the X-axis driving motor connected to an X-axis screw which spans the gantry bracket, and a plurality of X-axis guide shafts respectively disposed on the upper and lower sides of the X-axis screw respectively; wherein a connector is disposed on the X-axis screw and the X-axis guide shafts, and wherein the connector is connected to the Z-axis driving mechanism.

8. The engraving device according to claim 7, wherein the Z-axis driving mechanism comprises a Z-axis driving motor of which the spindle motor is connected to the connector, wherein the Z-axis driving motor is connected to a Z-axis screw of which both sides are respectively provided with a Z-axis guide shaft and an end of the Z-axis screw; wherein both ends of the Z-axis guide shaft are connected to the connector after passing through a clamp and the spindle motor, and wherein the Z-axis driving motor drives the spindle motor to move vertically.

9. The engraving device according to claim 7, wherein the Y-axis driving mechanism is disposed on the base frame and connected to the bottom of the processing platform; wherein the Y-axis driving mechanism comprises a Y-axis driving motor connected to a Y-axis screw; wherein Y-axis guide shafts are respectively disposed on both sides of the Y-axis screw; and wherein the Y-axis driving mechanism drives the processing platform to move on the Y-axis.

10. The engraving device according to claim 9, wherein both sides of the gantry bracket are respectively provided with a dust baffle; wherein one side of the X-axis driving motor is provided with a limit switch; and wherein an end of the Y-axis guide shafts away from the Y-axis driving motor is provided with the limit switch.
